(19) United States
(12) Patent Application Publication
(10) Pub. No.: US 2025/0182732 A1
(43) Pub. Date: Jun. 5, 2025

(54) MASKER SOUND GENERATION DEVICE, MASKER SOUND GENERATION METHOD, AND RECORDING MEDIUM

(71) Applicant: Panasonic Intellectual Property Management Co., Ltd., Osaka (JP)

(72) Inventors: Takeshi SAKAI, Hyogo (JP); Shinichiro KURIHARA, Hyogo (JP); Toya KITAGAWA, Osaka (JP)

(21) Appl. No.: 19/051,645

(22) Filed: Feb. 12, 2025

Related U.S. Application Data
(63) Continuation of application No. PCT/JP2022/043293, filed on Nov. 24, 2022.

(30) Foreign Application Priority Data
Aug. 15, 2022 (JP) 2022-129363

(51) Int. Cl. G10K 11/175

(52) U.S. Cl. CPC G10K 11/1752

(57) ABSTRACT

A masker sound generation device includes: an obtainer that obtains a collected-sound signal generated through sound collection by a microphone; a detector that detects, based on the collected-sound signal, a noise level in a sound collection space where the microphone is disposed; a first generator that generates a first masker sound signal according to the noise level; a second generator that generates, according to the noise level, a second masker sound signal having a sound pressure higher than a sound pressure of the first masker sound signal in a frequency band higher than a first frequency; a synthesizer that synthesizes the first masker sound signal and the second masker sound signal to generate a synthesized masker sound signal; and an outputter that outputs the synthesized masker sound signal to a loudspeaker that emits sound into a sound emission space.

### CROSS REFERENCE TO RELATED APPLICATIONS

This is a continuation application of PCT International Application No. PCT/JP2022/043293 filed on Nov. 24, 2022, designating the United States of America, which is based on and claims priority of Japanese Patent Application No. 2022-129363 filed on Aug. 15, 2022. The entire disclosures of the above-identified applications, including the specifications, drawings and claims are incorporated herein by reference in their entirety.

### FIELD

The present disclosure relates to a masker sound generation device, a masker sound generation method, and a recording medium.

### BACKGROUND

Patent Literature (PTL) 1 discloses a technology for emitting two kinds of masker sounds to reduce a sense of noisiness and discomfort caused to a person hearing sound.

### CITATION LIST

### Patent Literature

PTL 1: Japanese Unexamined Patent Application Publication No. 2011-154125

### SUMMARY

### Technical Problem

The present disclosure provides a masker sound generation device and so forth that are capable of generating a sound signal for providing a comfortable sound environment to a person who is using a space.

### Solution to Problem

According to an aspect of the present disclosure, a masker sound generation device includes: an obtainer that obtains a collected-sound signal generated through sound collection by a microphone; a detector that detects, based on the collected-sound signal, a noise level in a sound collection space where the microphone is disposed; a first generator that generates a first masker sound signal according to the noise level; a second generator that generates, according to the noise level, a second masker sound signal having a sound pressure higher than a sound pressure of the first masker sound signal in a frequency band higher than a first frequency; a synthesizer that synthesizes the first masker sound signal and the second masker sound signal to generate a synthesized masker sound signal; and an outputter that outputs the synthesized masker sound signal to a loudspeaker that emits sound into a sound emission space.

According to another aspect of the present disclosure, a masker sound generation method executed by a computer includes: obtaining a collected-sound signal generated through sound collection by a microphone; detecting, based on the collected-sound signal, a noise level in a sound collection space where the microphone is disposed; generating a first masker sound signal according to the noise level; generating, according to the noise level, a second masker sound signal having a sound pressure higher than a sound pressure of the first masker sound signal in a frequency band higher than a first frequency; synthesizing the first masker sound signal and the second masker sound signal to generate a synthesized masker sound signal; and outputting the synthesized masker sound signal to a loudspeaker that emits sound into a sound emission space.

General or specific aspects of the present disclosure may be implemented to an integrated circuit, a computer program, a non-transitory computer-readable recording medium such as a Compact Disc-Read Only Memory (CD-ROM), or any given combination thereof.

### Advantageous Effects

The masker sound generation device and so forth according to the present disclosure are capable of generating a sound signal for providing a comfortable sound environment to a person who is using a space.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating a space where a masker sound generation system is used according to Embodiment 1.

FIG. 2 is a diagram illustrating an example of using the masker sound generation system according to Embodiment 1.

FIG. 3 is a block diagram illustrating an example of a hardware configuration of a masker sound generation device according to Embodiment 1.

FIG. 4 is a block diagram illustrating an example of a functional configuration of the masker sound generation device according to Embodiment 1.

FIG. 5 is a schematic diagram illustrating an example of respective sound pressure frequency characteristics of sound signals representing first sound source data and second sound source data.

FIG. 6 is a table illustrating an overview of a method of generating a first masker sound signal and a second masker sound signal according to the noise level, according to Embodiment 1.

FIG. 7A is a schematic diagram illustrating respective sound pressure frequency characteristics of the first masker sound signal and the second masker sound signal at a noise level that is less than threshold value Th1.

FIG. 7B is a schematic diagram illustrating respective sound pressure frequency characteristics of the first masker sound signal and the second masker sound signal at a noise level that is at least threshold value Th1 and less than threshold value Th2.

FIG. 7C is a schematic diagram illustrating respective sound pressure frequency characteristics of the first masker sound signal and the second masker sound signal at a noise level that is at least threshold value Th2 and less than threshold value Th3.

FIG. 7D is a schematic diagram illustrating respective sound pressure frequency characteristics of the first masker sound signal and the second masker sound signal at a noise level that is at least threshold value Th3.

FIG. 8 is a flowchart illustrating an example of a masker sound generation method executed by the masker sound generation device according to Embodiment 1.

FIG. 9 is a diagram illustrating an example of using a masker sound generation system according to Embodiment 2.

FIG. 10 is a block diagram illustrating an example of a functional configuration of a masker sound generation device according to Embodiment 2.

FIG. 11 is a table illustrating an overview of a method of generating a first masker sound signal and a second masker sound signal according to the noise level, according to Embodiment 2.

FIG. 12 is a flowchart illustrating a masker sound generation method executed by the masker sound generation device according to Embodiment 2.

FIG. 13 is a flowchart illustrating an example of an activity determination method executed by a determiner.

### DESCRIPTION OF EMBODIMENTS

### (Underlying Knowledge Forming Basis of the Present Disclosure)

By the technology disclosed in PTL 1 described above, a second masker sound that reduces the impact of a first masker sound on the hearing sense is generated before the first masker sound and thus reduces the sense of noisiness and discomfort caused to the person that hears the first masker sound.

However, to emit the two kinds of masker sounds into a space used by a person, the aforementioned related art causes the masker sounds to be generated regardless of a sound pressure (noise level) of sound (noise) having an impact on a sound environment of this space. On this account, it is difficult to provide a sufficiently comfortable sound environment. For example, at a noise level higher than a specified threshold value, an increase in the sound pressure of the masker sound to reduce the impact of the noise on the person may make the masker sound itself an annoying sound for the person.

The present inventors have conducted intensive studies and found a masker sound generation device, a masker sound generation method, and a recording medium for providing a comfortable sound environment for a person, as described below.

According to a first aspect of the present disclosure, a masker sound generation device includes: an obtainer that obtains a collected-sound signal generated through sound collection by a microphone; a detector that detects, based on the collected-sound signal, a noise level in a sound collection space where the microphone is disposed; a first generator that generates a first masker sound signal according to the noise level; a second generator that generates, according to the noise level, a second masker sound signal having a sound pressure higher than a sound pressure of the first masker sound signal in a frequency band higher than a first frequency; a synthesizer that synthesizes the first masker sound signal and the second masker sound signal to generate a synthesized masker sound signal; and an outputter that outputs the synthesized masker sound signal to a loudspeaker that emits sound into a sound emission space.

With this, the first masker sound signal and the second masker sound signal are generated to achieve an optimal equivalent noise level corresponding to the noise level. Thus, the impact of the noise in the sound collection space on the person can be effectively reduced. Hence, the sound signal for providing a comfortable sound environment to the person who is using the sound emission space can be provided.

A masker sound generation device according to a second aspect is the masker sound generation device according to the first aspect, wherein the first generator generates the first masker sound signal having a highest frequency that is lower as the noise level is higher.

When the sound pressure of the first masker sound based on the first masker sound signal is adjusted to be at least a predetermined value, sound in the high frequency band is likely to cause discomfort to the person. For this reason, the first masker sound signal is generated in the way that the highest frequency is lower as the noise level is higher. With this, the sound that adversely affects the person can be cut off. Hence, the masker sound for reducing the discomfort caused to the person can be generated.

A masker sound generation device according to a third aspect is the masker sound generation device according to the first aspect, wherein the second generator generates the second masker sound signal having a lowest frequency that is higher as the noise level is higher.

A second masker sound based on the second masker sound signal has characteristics in the high frequency band. Thus, when the sound pressure of the second masker sound signal is adjusted to increase with the noise level, the low frequency band in which this signal has less characteristics is also accentuated. For this reason, the second masker sound signal is generated in the way that the lowest frequency is higher as the noise level is higher. With this, the high frequency band in which this signal has the characteristics remains. Hence, the sound signal for providing a comfortable sound environment to the person who is using the sound emission space can be provided.

A masker sound generation device according to a fourth aspect is the masker sound generation device according to the second aspect, wherein the second generator generates the second masker sound signal having a lowest frequency that is higher as the noise level is higher.

The second masker sound based on the second masker sound signal has characteristics in the high frequency band. Thus, when the sound pressure of the second masker sound signal is adjusted to increase with the noise level, the low frequency band in which this signal has less characteristics is also accentuated. For this reason, the second masker sound signal is generated in the way that the lowest frequency is higher as the noise level is higher. With this, the high frequency band in which this signal has the characteristics remains. Furthermore, although the high frequency band of the first masker sound signal is cut off, the high frequency band can be compensated for by the second masker sound signal. Hence, the sound signal for providing a more comfortable sound environment to the person who is using the sound emission space can be provided.

A masker sound generation device according to a fifth aspect is the masker sound generation device according to the fourth aspect, wherein when the noise level is at least a first threshold value, the first generator generates the first masker sound signal from which a full frequency band is cut off and the second generator generates the second masker sound signal which has an equivalent noise level corresponding to the noise level and from which a frequency band lower than the first frequency is cut off.

When the sound pressure of the first masker sound based on the first masker sound signal is adjusted to be at least a predetermined value, sound in the high frequency band is likely to cause discomfort to a person. For this reason, when the noise level is higher than the first threshold value, the first masker sound signal is generated in the way that allows the full frequency band to be cut off (that is, allows the sound pressure to be 0 over the full frequency band). With this, the sound that adversely affects the person can be cut off. The second masker sound based on the second masker sound signal has characteristics in the high frequency band. Thus, when the sound pressure of the second masker sound signal is adjusted to increase with the noise level, the low frequency band in which this signal has less characteristics is also accentuated. For this reason, the second masker sound signal is generated in the way that the lowest frequency is higher as the noise level is higher. With this, the high frequency band in which this signal has the characteristics remains. Hence, the sound signal for providing a comfortable sound environment to the person who is using the sound emission space can be provided.

A masker sound generation device according to a sixth aspect is the masker sound generation device according to the fourth aspect or the fifth aspect, wherein when the noise level is at least a second threshold value and is less than the first threshold value, the second threshold value being less than the first threshold value, the first generator generates the first masker sound signal having an equivalent noise level corresponding to the noise level and the second generator generates the second masker sound signal having the equivalent noise level corresponding to the noise level.

With this, the first masker sound signal and the second masker sound signal are generated to achieve an optimal equivalent noise level corresponding to the noise level. Thus, the impact of the noise in the sound collection space on the person can be effectively reduced. Hence, the sound signal for providing a comfortable sound environment to the person who is using the sound emission space can be provided.

A masker sound generation device according to a seventh aspect is the masker sound generation device according to the sixth aspect, wherein when the noise level is at least a third threshold value and is less than the first threshold value, the third threshold value being greater than the second threshold value and less than the first threshold value, the first generator generates the first masker sound signal from which a frequency band higher than a second frequency is cut off and the second generator generates the second masker sound signal from which a frequency band lower than the first frequency is cut off.

When the sound pressure of the first masker sound based on the first masker sound signal is adjusted to be at least a predetermined value, sound in the high frequency band is likely to cause discomfort to a person. For this reason, when the noise level is higher than the second threshold value, the first masker sound signal is generated in the way that allows the frequency band higher than the second frequency to be cut off. With this, the sound that adversely affects the person can be cut off. Furthermore, the second masker sound based on the second masker sound signal has characteristics in the high frequency band. Thus, when the sound pressure of the second masker sound signal is adjusted to increase with the noise level, the low frequency band in which this signal has less characteristics is also accentuated. For this reason, the second masker sound signal is generated in the way that allows the frequency band lower than the first frequency to be cut off. With this, the high frequency band in which this signal has the characteristics remains. Hence, the sound signal for providing a comfortable sound environment to the person who is using the sound emission space can be provided.

A masker sound generation device according to an eighth aspect is the masker sound generation device according to any one of the fourth to seventh aspects, wherein when the noise level is less than the second threshold value, the first generator generates the first masker sound signal having an equivalent noise level corresponding to the second threshold value and the second generator generates the second masker sound signal having the equivalent noise level corresponding to the second threshold value.

With this, when the noise level is less than the second threshold value, the first masker sound signal and the second masker sound signal are generated to achieve the equivalent noise level corresponding to the second threshold value. Thus, the first masker sound signal and the second masker sound signal can be generated to achieve an optimal equivalent noise level corresponding to the noise level. Hence, the sound signal for providing a comfortable sound environment to the person who is using the sound emission space can be provided.

A masker sound generation device according to a ninth aspect is the masker sound generation device according to any one of the first to eighth aspects which includes: a determiner that determines an activity of at least one person present in the sound emission space, wherein when the determiner determines that the activity is a break, the first generator generates the first masker sound signal having an equivalent noise level higher than an equivalent noise level achieved when the determiner determines that the activity is an intellectual activity, and when the determiner determines the activity is the break, the second generator generates the second masker sound signal having the equivalent noise level higher than the equivalent noise level achieved when the determiner determines that the activity is the intellectual activity.

It was found that a person is able to take a break more efficiently when the sound pressure of the masker sound is higher than the sound pressure used during an intellectual activity. On this account, the equivalent noise level of the masker sound signal generated during a break is made higher than the equivalent noise level of the masker sound signal generated during an intellectual activity. This allows the person to take a break more efficiently.

A masker sound generation device according to a tenth aspect is the masker sound generation device according to the ninth aspect, wherein when the determiner determines that the activity is an intellectual activity performed by at least two persons, the first generator generates the first masker sound signal having an equivalent noise level higher than an equivalent noise level achieved when the determiner determines that the activity is an intellectual activity performed by one person, and when the determiner determines that the activity is the intellectual activity performed by the at least two persons, the second generator generates the second masker sound signal having the equivalent noise level higher than the equivalent noise level achieved when the determiner determines that the activity is the intellectual activity performed by the one person.

It was found that when a person performs an intellectual activity together with at least one person, the person is able to perform the intellectual activity more efficiently when the sound pressure of the masker sound signal is higher than the sound pressure used when the person performs the intellectual activity alone. On this account, the equivalent noise level of the masker sound signal generated during an intellectual activity performed by a plurality of persons is made higher than the equivalent noise level of the masker sound signal generated during an intellectual activity performed by one person. This allows the person to perform the intellectual activity more efficiently.

A masker sound generation device according to an eleventh aspect is the masker sound generation device according to any one of the first to tenth aspects which includes: the microphone; and the loudspeaker, wherein the microphone is disposed in a direction opposite to a direction in which the loudspeaker emits sound.

A masker sound generation device according to a twelfth aspect is the masker sound generation device according to any one of the first to eleventh aspects, wherein the first masker sound signal is a sound signal for masking noise, and the second masker sound signal is a sound signal for embellishing a first masker sound based on the first masker sound signal.

According to a thirteenth aspect of the present disclosure, a masker sound generation method executed by a computer includes: obtaining a collected-sound signal generated through sound collection by a microphone; detecting, based on the collected-sound signal, a noise level in a sound collection space where the microphone is disposed; generating a first masker sound signal according to the noise level; generating, according to the noise level, a second masker sound signal having a sound pressure higher than a sound pressure of the first masker sound signal in a frequency band higher than a first frequency; synthesizing the first masker sound signal and the second masker sound signal to generate a synthesized masker sound signal; and outputting the synthesized masker sound signal to a loudspeaker that emits sound into a sound emission space.

With this, the first masker sound signal and the second masker sound signal are generated to achieve an optimal equivalent noise level corresponding to the noise level. Thus, the impact of the noise in the sound collection space on the person can be effectively reduced. Hence, the sound signal for providing a comfortable sound environment to the person who is using the sound emission space can be provided.

According to a fourteenth aspect of the present disclosure, a non-transitory computer-readable recording medium for use in a computer has recorded thereon a computer program for causing the computer to execute the masker sound generation method according to the thirteenth aspect.

General or specific aspects of the present disclosure may be implemented to an integrated circuit, a computer program, a non-transitory computer-readable recording medium such as a Compact Disc-Read Only Memory (CD-ROM), or any given combination thereof.

Hereinafter, certain exemplary embodiments will be described in detail with reference to the accompanying Drawings. Hereinafter, certain exemplary embodiments will be described in detail with reference to the accompanying Drawings. However, unnecessarily detailed description may be omitted. For example, detailed explanation of a well-known matter and repeated description of substantially identical structures may be omitted. Such omission makes the following description exclude unnecessary redundancy and be easily understood by those skilled in the art.

It should be noted that the accompanying drawings and subsequent description are provided by the inventors of the present invention to facilitate sufficient understanding of the present disclosure by those skilled in the art, and are thus not intended to limit the scope of the subject matter recited in the claims.

### Embodiment 1

### 1-1. Configuration

### [Overview of Masker Sound System]

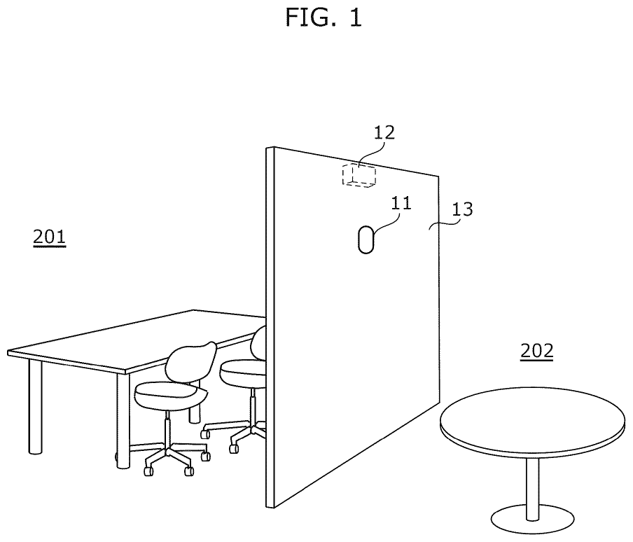

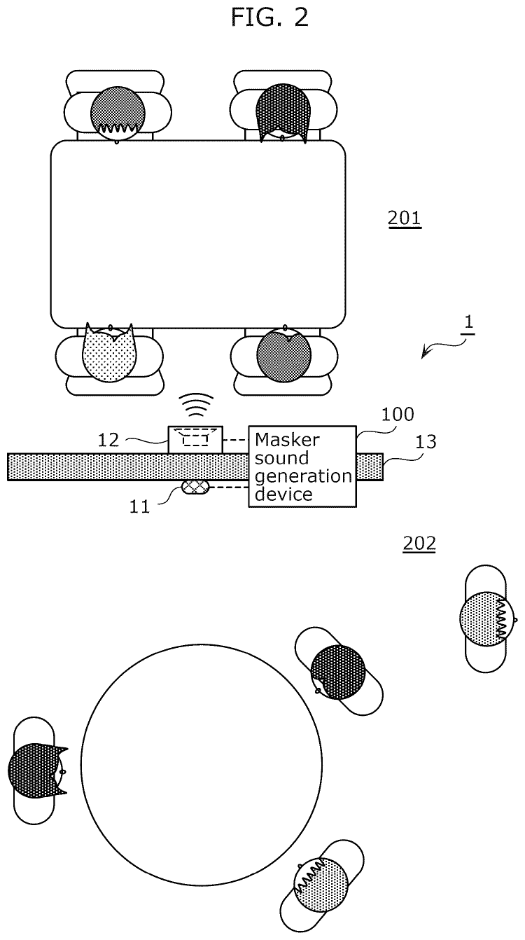

FIG. 1 is a diagram illustrating a space where a masker sound generation system is used according to Embodiment 1. FIG. 2 is a diagram illustrating an example of using the masker sound generation system according to Embodiment 1. FIG. 2 is a top view of masker sound generation system 1.

In each of FIG. 1 and FIG. 2, first space 201 and second space 202 are separated by partition 13. On partition 13 disposed on the border between first space 201 and second space 202, loudspeaker device 12 is disposed to face in the direction of first space 201 and microphone 11 is disposed to face in the direction of second space 202. First space 201 is a space that may be used by at least one person, as a space (working space) in which a person works. Second space 202 is a space that may be shared by a large number of unspecified people, such as a lobby where people come and go or take a temporary break. First space 201 is an example of a sound emission space. Second space 202 is an example of a sound collection space.

FIG. 2 is a diagram illustrating masker sound generation system 1 that includes masker sound generation device 100, microphone 11, and loudspeaker device 12.

Microphone 11 is disposed on second space 202 side of partition 13. Microphone 11 collects sound generated in second space 202 and then outputs a collected-sound signal. Note that although microphone 11 is disposed on partition 13, this is not intended to be limiting. Microphone 11 may be disposed on any position that allows microphone 11 to collect sound generated in second space 202. For example, microphone 11 may be disposed on the ceiling of second space 202, on a wall placed in second space 202, or on the floor of second space 202. Alternatively, microphone 11 may be disposed on a desk or a chair placed in second space 202.

Loudspeaker device 12 is disposed on first space 201 side of partition 13. Loudspeaker device 12 outputs sound (masking sound) that makes sound generated in second space 202 difficult to be heard by a person present in first space 201. Here, examples of the sound generated in second space 202 include a conversation of a user who is using second space 202, sound made by a movement, and operating sound of equipment disposed in second space 202. The conversion of the user who is using second space 202 may be a conversation among a plurality of users who are using second space 202 or a conversation through a voice call using communication terminals between the user who is using second space 202 and a user outside second space 202. Note that loudspeaker device 12 may include a loudspeaker array including a plurality of loudspeaker units arranged in a specified direction, and that the directivity of loudspeaker device 12 may be controllable in a specified direction.

Note that, before microphone 11 and loudspeaker device 12 are placed, respective positions or orientations of microphone 11 and loudspeaker device 12 may be adjusted in a manner that makes it hard for microphone 11 to collect sound outputted by loudspeaker device 12. Furthermore, the volume of loudspeaker device 12 and the sensitivity of microphone 11 may be adjusted in a manner that makes it hard for microphone 11 to collect sound outputted by loudspeaker device 12. When arranged in a manner that makes it hard for microphone 11 to collect sound outputted by loudspeaker device 12, microphone 11 and loudspeaker device 12 need not be disposed on partition 13.

Masker sound generation device 100 obtains a detection result from microphone 11 and generates, based on the obtained detection result, masker sound that is outputted from loudspeaker device 12.

### [Hardware Configuration of Masker Sound Generation Device]

Next, a specific configuration of masker sound generation device 100 is described.

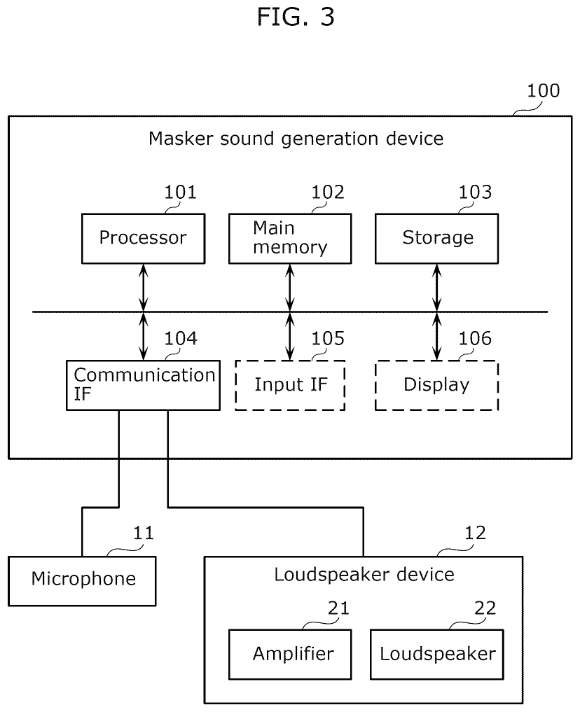

FIG. 3 is a block diagram illustrating an example of a hardware configuration of the masker sound generation device according to Embodiment 1.

As illustrated in FIG. 3, masker sound generation device 100 has a hardware configuration including processor 101, main memory 102, storage 103, and communication interface (IF) 104. Masker sound generation device 100 may also include input IF 105 and display 106.

Processor 101 executes programs stored in, for example, storage 103.

Main memory 102 is a volatile storage area that is used: for temporarily storing data generated during processing performed by processor 101; as a work area by processor 101 for executing a program; and for temporarily storing data received by communication IF 104. The data generated during the processing performed by processor 101 includes a masker sound signal that is a sound signal representing masker sound generated by processor 101, for example. The data received by communication IF 104 includes a sound signal obtained from microphone 11, for example.

Storage 103 is a nonvolatile storage device that holds various kinds of data, such as programs. For example, storage 103 stores various kinds of data generated as a result of processing performed by processor 101. Furthermore, storage 103 stores sound source data used for generating masker sound.

Communication IF 104 is a communication interface used for data transmission to and from an external device, such as a smartphone, a tablet, a personal computer (PC), or a server. Communication IF 104 may be a wireless communication interface, such as a wireless LAN interface or a Bluetooth (registered trademark) interface. Communication IF 104 may be a wired communication interface, such as a universal serial bus (USB) or a wired LAN interface. Note that communication IF 104 is not limited to the aforementioned examples and may be a communication interface used for data transmission to and from an external device via a communication network. Communication IF 104 receives a collected-sound signal from microphone 11, for example.

Input IF 105 is an interface used for receiving an input from a person. Input IF 105 may be a keyboard or a pointing device, such as a mouse, a touch pad, a touch panel, or a trackball.

Display 106 is a device that displays at least a part of a result of processing performed by processor 101. Display 106 is a liquid crystal display or an organic EL display, for example.

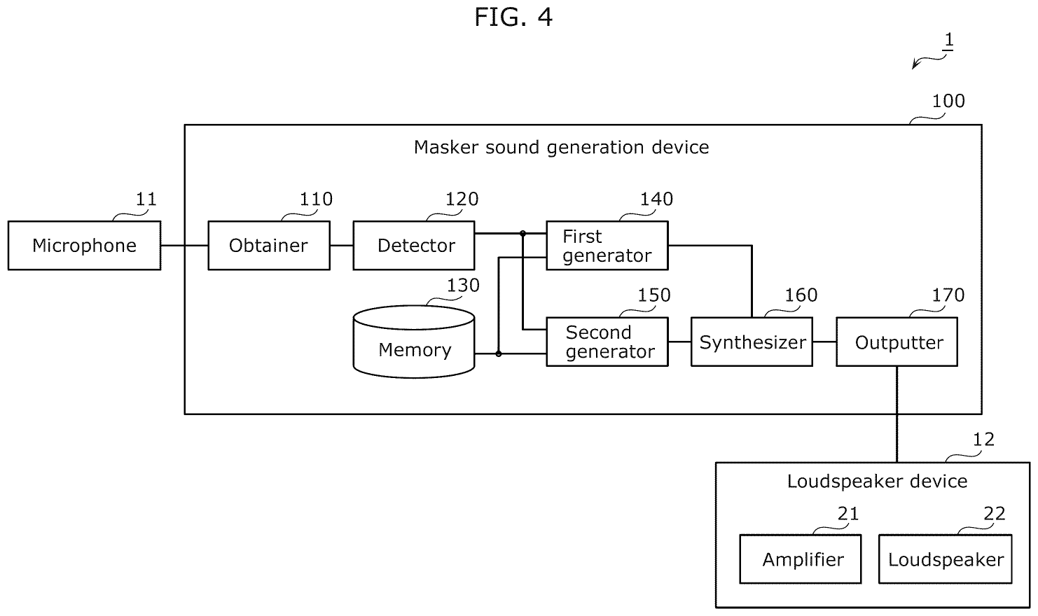

FIG. 4 is a block diagram illustrating an example of a functional configuration of the masker sound generation device according to Embodiment 1.

As illustrated in FIG. 4, masker sound generation device 100 includes obtainer 110, detector 120, memory 130, first generator 140, second generator 150, synthesizer 160, and outputter 170.

Obtainer 110 obtains a collected-sound signal generated through sound collection by microphone 11. Obtainer 110 obtains, in real time, the collected-sound signals sequentially generated. Obtainer 110 is implemented by communication IF 104, for example.

Detector 120 detects, based on the collected-sound signal, a noise level (equivalent noise level) in second space 202 where microphone 11 is disposed. To be more specific, detector 120 detects, based on the collected-sound signal, the noise level in second space 202 by determining, through analysis of the collected-sound signal, sound loudness indicated by the collected-sound signal. The sound loudness indicated by the collected-sound signal may be an amplitude at a peak of a sound waveform of the collected-sound signal over a predetermined duration. When a plurality of peaks occur during the predetermined duration, the sound loudness indicated by the collected-sound signal may be the maximum value or an average value among the amplitudes corresponding to the plurality of peaks. For example, the predetermined duration is a duration measured from a time a predetermined period of time before the current time (that is, the latest time when the collected-sound signal was generated) to the current time. The predetermined period of time indicates a time interval, and may be 100 seconds or less, for example. Furthermore, the sound loudness indicated by the collected-sound signal may be the amplitude of an envelope connecting tangents of peaks of the sound waveform of the collected-sound signal at the current time. Alternatively, the sound loudness may be the maximum value or an average value over the predetermined duration. Detector 120 detects the noise level in second space 202 in real time and outputs the detection result to first generator 140 and second generator 150. Detector 120 is implemented by processor 101 executing a program stored in storage 103 using main memory 102, for example.

Memory 130 stores sound source data. The sound source data includes: first sound source data used by first generator 140 to generate a first masker sound signal; and second sound source data used by second generator 150 to generate a second masker sound signal. The first sound source data and the second sound source data may be sound source data that is prepared beforehand.

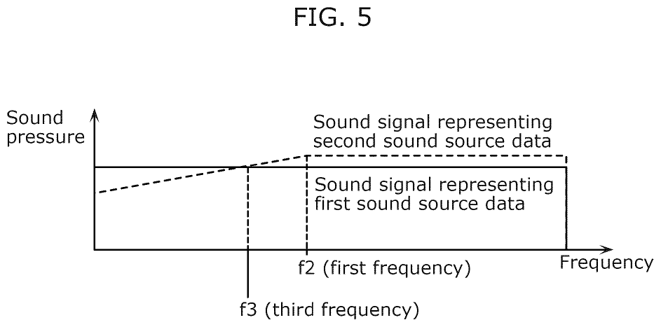

FIG. 5 is a schematic diagram illustrating an example of respective sound pressure frequency characteristics of sound signals representing the first sound source data and the second sound source data.

A sound signal representing the first sound source data is used for masking noise, such as colored noise including white noise. A sound signal representing the second sound source data has a sound pressure higher than a sound pressure of the sound signal representing the first sound source data in a frequency band higher than frequency f2 (a first frequency). Furthermore, the sound signal representing the second sound source data has the sound pressure lower than the sound pressure of the sound signal representing the first sound source data in a frequency band lower than frequency f3 (a third frequency) that is lower than frequency f2 (the first frequency). For example, after noise in the sound signal representing the second sound source data is reduced by time averaging, sound pressure frequency characteristics of the sound signal representing the second sound source data may have a sound pressure that is: higher than a sound pressure of the sound signal representing the first sound source data in a frequency band higher than the first frequency; and lower than the sound pressure of the sound signal representing the first sound source data, in a frequency band lower than the third frequency. The sound signal representing the second sound source data is used for embellishing a first masker sound based on the first masker sound signal. For example, the sound signal representing the second sound source data is environmental sound recorded beforehand in nature for instance. Furthermore, the sound source data that is prepared beforehand may be data indicating sound collected beforehand by microphone 11.

Note that memory 130 is implemented by storage 103, for example.

Note that the sound source data need not be prepared beforehand and may be obtained by obtainer 110 from an external device via a network. The sound source data obtained by obtainer 110 from the external device is stored into memory 130.

First generator 140 generates the first masker sound signal by processing the sound signal representing the first sound source data according to the noise level detected by detector 120. To be more specific, first generator 140 generates the first masker sound signal in a way that allows the highest frequency of the first masker sound signal decreases as the noise level increases. For example, the first masker sound signal is a sound signal representing white noise that has sound pressure frequency characteristics with the sound pressure being within a predetermined sound pressure range over the entire frequency band. Specific examples of the first masker sound signal are described later. First generator 140 is implemented by processor 101 executing a program stored in storage 103 using main memory 102, for example.

Second generator 150 generates the second masker sound signal by processing the sound signal representing the second sound source data according to the noise level detected by detector 120. The second masker sound signal has a sound pressure higher than the sound pressure of the first masker sound signal in the frequency band higher than the first frequency. To be more specific, second generator 150 generates the second masker sound signal in a way that allows the lowest frequency of the second masker sound signal increases as the noise level increases. Specific examples of the second masker sound signal are described later. Second generator 150 is implemented by processor 101 executing a program stored in storage 103 using main memory 102, for example.

Synthesizer 160 generates a synthesized masker sound signal by synthesizing the first masker sound signal and the second masker sound signal. Synthesizer 160 is implemented by processor 101 executing a program stored in storage 103 using main memory 102, for example.

Outputter 170 outputs the synthesized masker sound signal generated by synthesizer 160 to loudspeaker device 12. Outputter 170 is implemented by communication IF 104, for example.

Loudspeaker device 12 includes amplifier 21 and loudspeaker 22. The synthesized masker sound signal outputted from masker sound generation device 100 is amplified by amplifier 21. Then, the amplified sound signal drives loudspeaker 22. Loudspeaker 22 emits sound based on the amplified sound signal into first space 201. Note that loudspeaker device 12 need not include amplifier 21. For example, amplifier 21 may be included in masker sound generation device 100 or in a device different from masker sound generation device 100. Alternatively, amplifier 21 may be a device separate from masker sound generation device 100 and loudspeaker device 12 and may be connected to masker sound generation device 100 and loudspeaker device 12.

### [First Masker Sound Signal and Second Masker Sound Signal]

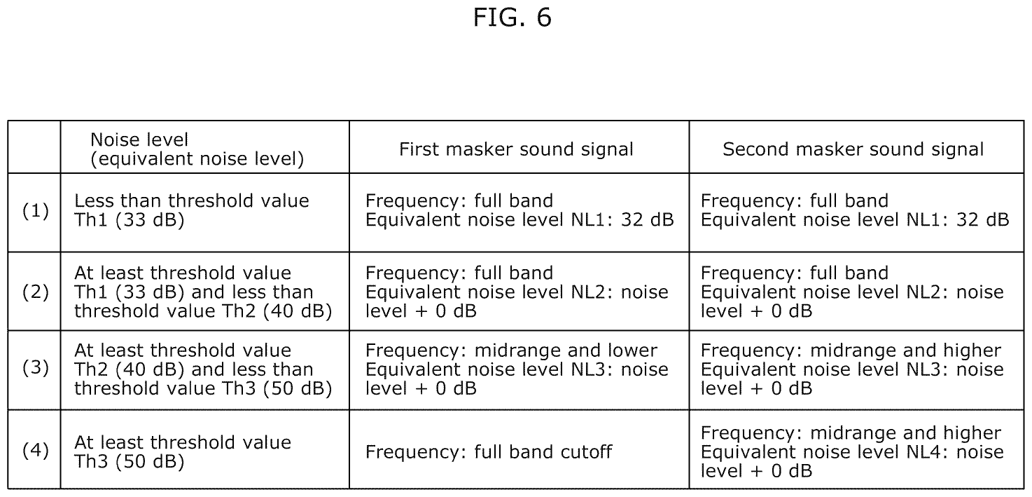

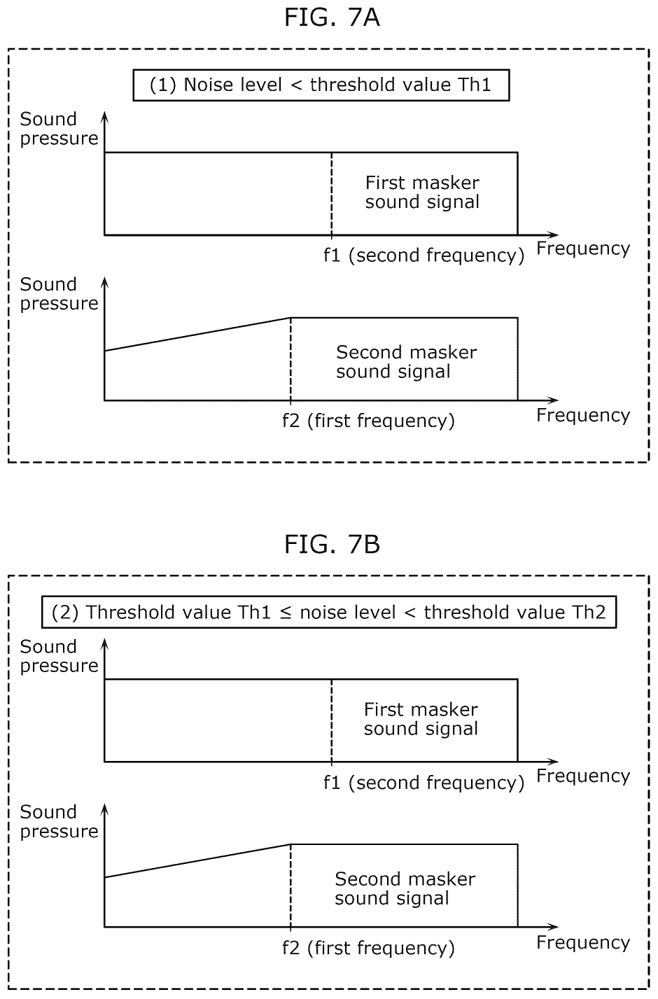

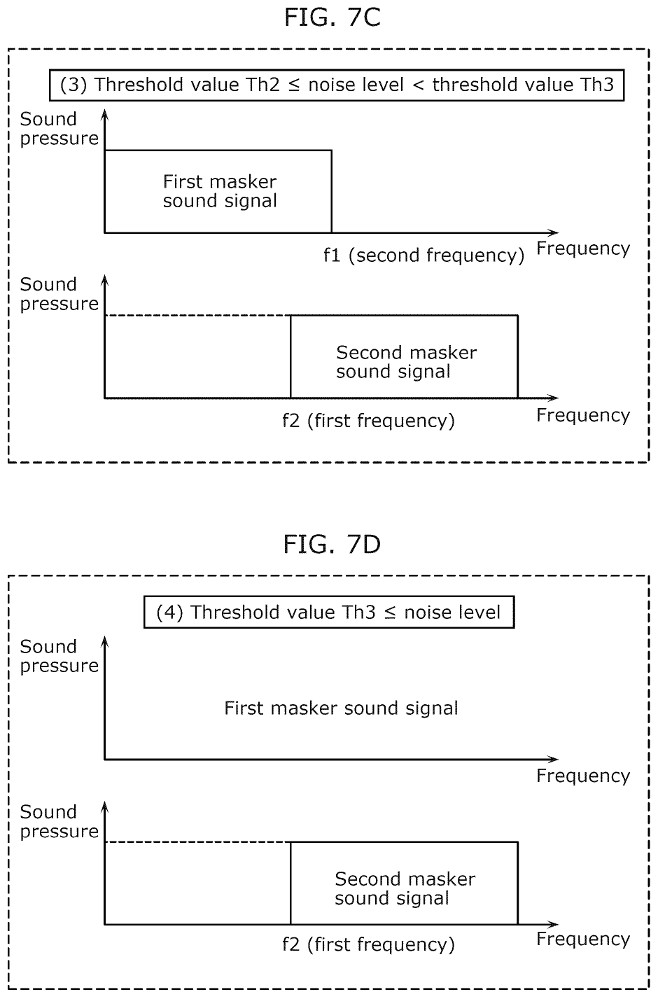

Next, specific examples of the first masker sound signal generated by first generator 140 and the second masker sound signal generated by second generator 150 are described with reference to FIG. 6 and FIG. 7A to FIG. 7D.

FIG. 6 is a table illustrating an overview of a method of generating the first masker sound signal and the second masker sound signal according to the noise level, according to Embodiment 1. FIG. 7A is a schematic diagram illustrating the respective sound pressure frequency characteristics of the first masker sound signal and the second masker sound signal at a noise level that is less than threshold value Th1. FIG. 7B is a schematic diagram illustrating the respective sound pressure frequency characteristics of the first masker sound signal and the second masker sound signal at a noise level that is at least threshold value Th1 and less than threshold value Th2. FIG. 7C is a schematic diagram illustrating the respective sound pressure frequency characteristics of the first masker sound signal and the second masker sound signal at a noise level that is at least threshold value Th2 and less than threshold value Th3. FIG. 7D is a schematic diagram illustrating the respective sound pressure frequency characteristics of the first masker sound signal and the second masker sound signal at a noise level that is at least threshold value Th3.

As described above, first generator 140 and second generator 150 generate the first masker sound signal and the second masker sound signal, respectively, according to the noise level in second space 202. Each of the first masker sound signal and the second masker sound signal is generated differently depending on the noise level. For example, each of the first masker sound signal and the second masker sound signal is generated differently at each of four different noise levels. The four noise levels include: (1) the noise level that is less than threshold value Th1; (2) the noise level that is at least threshold value Th1 and less than threshold value Th2; (3) the noise level that is at least threshold value Th2 and less than threshold value Th3; and (4) the noise level that is at least threshold value Th3. Note that threshold value Th1 is less than threshold value Th2 and that threshold value Th2 is less than threshold value Th3. Threshold value Th1 is 33 dB for instance, and is an example of a second threshold value. Threshold value Th2 is 40 dB for instance, and is an example of a third threshold value. Threshold value Th3 is 50 dB for instance, and is an example of a first threshold value. The specific examples of threshold value Th1, threshold value Th2, and threshold value Th3 are not limited to the aforementioned specific values. The specific examples may also include values obtained by adding 1 dB to 3 dB to, or subtracting 1 dB to 3 dB from, the aforementioned specific values.

(1) The case where the noise level is less than threshold value Th1 is described with reference to FIG. 6 and FIG. 7A. In this case, first generator 140 generates the first masker sound signal by adjusting the sound pressure of the sound signal representing the first sound source data to achieve equivalent noise level NL1 (that is, a fixed equivalent noise level) corresponding to threshold value Th1. To be more specific, by adjusting (amplifying or attenuating) the amplitude of the sound signal through application of gain to the sound signal representing the first sound source data, first generator 140 adjusts the sound pressure of the sound signal representing the first sound source data to allow the resulting equivalent noise level of the sound signal to reach equivalent noise level NL1. Equivalent noise level NL1 is a value (32 dB, for example) obtained by subtracting 1 dB from threshold value Th1, for example. In this way, at the noise level that is less than threshold value Th1, equivalent noise level NL1 is a target value toward which first generator 140 adjusts the sound pressure of the sound signal representing the first sound source data.

Note that the equivalent noise level refers to an energy average of sound based on the sound signal varying in the sound pressure (noise level) and represents a time average value of total energy of this sound over a specified period of time.

Furthermore, in this case, as with first generator 140, second generator 150 generates the second masker sound signal by adjusting the sound pressure of the sound signal representing the second sound source data to achieve equivalent noise level NL1 corresponding to threshold value Th1. To be more specific, by adjusting (amplifying or attenuating) the amplitude of the sound signal through application of gain to the sound signal representing the second sound source data, second generator 150 adjusts the sound pressure of the sound signal representing the second sound source data to allow the resulting equivalent noise level of the sound signal to reach equivalent noise level NL1. In this way, at the noise level that is less than threshold value Th1, equivalent noise level NL1 is a target value toward which second generator 150 adjusts the sound pressure of the sound signal representing the second sound source data.

In the case of (1), first generator 140 generates the first masker sound signal, without cutting off any specific frequency band of the sound signal representing the first sound source data, or more specifically, using the full frequency band of the sound signal representing the first sound source data. Similarly, second generator 150 generates the second masker sound signal, without cutting off any specific frequency band of the sound signal representing the second sound source data, or more specifically, using the full frequency band of the sound signal representing the second sound source data.

Note that, in the case of (1), equivalent noise level NL1 that is the target value toward which first generator 140 and second generator 150 generate the first masker sound signal and the second masker sound signal, respectively, corresponding to threshold value Th1 is not limited to the value obtained by subtracting 1 dB from threshold value Th1. Equivalent noise level NL1 may be a value obtained by subtracting 1 dB to 3 dB from threshold value Th1, or a value obtained by multiplying threshold value Th1 by a ratio less than 1. More specifically, equivalent noise level NL1 may be a value less than threshold value Th1. Note that equivalent noise level NL1 may be a value that is at least threshold value Th1.

(2) The case where the noise level is at least threshold value Th1 and less than threshold value Th2 is described with reference to FIG. 6 and FIG. 7B. In this case, first generator 140 generates the first masker sound signal by adjusting the sound pressure of the sound signal representing the first sound source data to achieve equivalent noise level NL2 corresponding to the noise level. To be more specific, by adjusting (amplifying or attenuating) the amplitude of the sound signal through application of gain to the sound signal representing the first sound source data, first generator 140 adjusts the sound pressure of the sound signal representing the first sound source data to allow the resulting equivalent noise level of the sound signal to reach equivalent noise level NL2. Equivalent noise level NL2 is equal in sound pressure to the noise level, for example. In this way, at the noise level that is at least threshold value Th1 and less than threshold value Th2, equivalent noise level NL2 is a target value toward which first generator 140 adjusts the sound pressure of the sound signal representing the first sound source data.

Furthermore, in this case, as with first generator 140, second generator 150 generates the second masker sound signal by adjusting the sound pressure of the sound signal representing the second sound source data to achieve equivalent noise level NL2 corresponding to the noise level. To be more specific, by adjusting (amplifying or attenuating) the amplitude of the sound signal through application of gain to the sound signal representing the second sound source data, second generator 150 adjusts the sound pressure of the sound signal representing the second sound source data to allow the resulting equivalent noise level of the sound signal to reach equivalent noise level NL2. In this way, at the noise level that is at least threshold value Th1 and less than threshold value Th2, equivalent noise level NL2 is a target value toward which second generator 150 adjusts the sound pressure of the sound signal representing the second sound source data.

In the case of (2), first generator 140 generates the first masker sound signal, without cutting off any specific frequency band of the sound signal representing the first sound source data, or more specifically, using the full frequency band of the sound signal representing the first sound source data. Similarly, second generator 150 generates the second masker sound signal, without cutting off any specific frequency band of the sound signal representing the second sound source data, or more specifically, using the full frequency band of the sound signal representing the second sound source data.

(3) The case where the noise level is at least threshold value Th2 and less than threshold value Th3 is described with reference to FIG. 6 and FIG. 7C. In this case, first generator 140 generates the first masker sound signal by adjusting the sound pressure of the sound signal representing the first sound source data to achieve equivalent noise level NL3 corresponding to the noise level. To be more specific, by adjusting (amplifying or attenuating) the amplitude of the sound signal through application of gain to the sound signal representing the first sound source data, first generator 140 adjusts the sound pressure of the sound signal representing the first sound source data to allow the resulting equivalent noise level of the sound signal to reach equivalent noise level NL3. Equivalent noise level NL3 is equal in sound pressure to the noise level, for example. In this way, at the noise level that is at least threshold value Th2 and less than threshold value Th3, equivalent noise level NL3 is a target value toward which first generator 140 adjusts the sound pressure of the sound signal representing the first sound source data.

Furthermore, in this case, as with first generator 140, second generator 150 generates the second masker sound signal by adjusting the sound pressure of the sound signal representing the second sound source data to achieve equivalent noise level NL3. To be more specific, by adjusting (amplifying or attenuating) the amplitude of the sound signal through application of gain to the sound signal representing the second sound source data, second generator 150 adjusts the sound pressure of the sound signal representing the second sound source data to allow the resulting equivalent noise level of the sound signal to reach equivalent noise level NL3. In this way, at the noise level that is at least threshold value Th2 and less than threshold value Th3, equivalent noise level NL3 is a target value toward which second generator 150 adjusts the sound pressure of the sound signal representing the second sound source data.

Furthermore, in the case of (3), first generator 140 generates the first masker sound signal in a way that allows a frequency band higher than frequency f1 to be cut off. For example, frequency f1 is 5 kHz and thus first generator 140 generates the first masker sound signal by cutting off the frequency band higher than 5 kHz from the sound signal representing the first sound source data. Frequency f1 is an example of a second frequency. Note that frequency f1 is not limited to 5 kHz and may be a frequency included in 1 kHz to 5 kHz. In this case, second generator 150 generates the second masker sound signal in a way that allows a frequency band lower than frequency f2 to be cut off. For example, frequency f2 is 1 kHz and thus second generator 150 generates the second masker sound signal by cutting off the frequency band lower than 1 kHz from the sound signal representing the second sound source data. Frequency f2 is an example of the first frequency. Note that frequency f2 is not limited to 1 kHz and may be a frequency included in 0.1 kHz to 2 kHz.

(4) The case where the noise level is at least threshold value Th3 is described with reference to FIG. 6 and FIG. 7D. In this case, first generator 140 generates the first masker sound signal by adjusting the sound pressure of the sound signal representing the first sound source data by cutting off the full frequency band (that is, by allowing the sound pressure to be 0 in the full frequency band). To be more specific, first generator 140 generates, as the first masker sound signal, a sound signal in which the full frequency band is cut off. In other words, first generator 140 generates a silent signal as the first masker sound signal. Furthermore, in this case, second generator 150 generates the second masker sound signal by adjusting the sound pressure of the sound signal representing the second sound source data to achieve equivalent noise level NL4 corresponding to the noise level. Equivalent noise level NL4 is equal in sound pressure to the noise level, for example. To be more specific, by adjusting (amplifying or attenuating) the amplitude of the sound signal through application of gain to the sound signal representing the second sound source data, second generator 150 adjusts the sound pressure of the sound signal representing the second sound source data to allow the resulting equivalent noise level of the sound signal to reach equivalent noise level NL4. In this way, at the noise level that is at least threshold value Th3, equivalent noise level NL4 is a target value toward which second generator 150 adjusts the sound pressure of the sound signal representing the second sound source data.

Furthermore, second generator 150 generates the second masker sound signal in a way that allows a frequency band lower than frequency f2 to be cut off. For example, second generator 150 generates the second masker sound signal by cutting off the frequency band lower than 1 kHz from the sound signal representing the second sound source data.

As described above for the four noise levels (1) to (4), the first masker sound signal is generated in the way that allows the frequency band higher than frequency f1 to be cut off in the case of (3) and in the way that allows the full frequency band to be cut off in the case of (4), as compared to the cases of (1) and (2). More specifically, the first masker sound signal is generated in a way that the highest frequency is lower as the noise level is higher.

As described above for the four noise levels (1) to (4), the second masker sound signal is generated in the way that allows the frequency band lower than frequency f2 to be cut off in the cases of (3) and (4), as compared to the cases of (1) and (2). More specifically, the second masker sound signal is generated in a way that the lowest frequency is higher as the noise level is higher.

### 1-2. Operation

Next, an operation performed by masker sound generation device 100 according to Embodiment 1 is described.

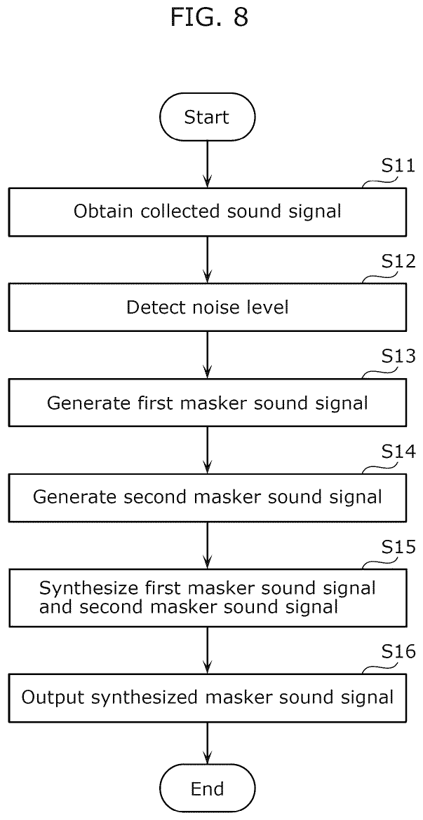

FIG. 8 is a flowchart illustrating an example of a masker sound generation method executed by the masker sound generation device according to Embodiment 1.

First, obtainer 110 obtains the collected-sound signal generated through the sound collection by microphone 11 (S11).

Next, detector 120 detects, based on the collected-sound signal, the noise level in second space 202 where microphone 11 is disposed (S12).

Next, according to the noise level detected by detector 120, first generator 140 generates the first masker sound signal by processing the sound signal representing the first sound source data (S13). To be more specific, first generator 140 generates the first masker sound signal as described with reference to FIG. 6 and FIG. 7A to FIG. 7D.

Next, according to the noise level detected by detector 120, second generator 150 generates the second masker sound signal by processing the sound signal representing the second sound source data (S14). To be more specific, second generator 150 generates the second masker sound signal as described with reference to FIG. 6 and FIG. 7A to FIG. 7D.

Note that the order in which Step S13 and Step S14 are performed is not limited to the order described above. Step S14 may be performed before Step S13. Alternatively, Step S13 and Step S14 may be performed concurrently.

Next, synthesizer 160 synthesizes the first masker sound signal and the second masker sound signal (S15). As a result, the synthesized masker sound signal is generated.

Next, outputter 170 outputs the synthesized masker sound signal to loudspeaker device 12 (S16). This enables loudspeaker device 12 to emit the synthesized masker sound based on the synthesized masker sound signal into first space 201.

### 1-3. Advantageous Effects Etc.

Masker sound generation device 100 according to the present embodiment includes obtainer 110, detector 120, first generator 140, second generator 150, synthesizer 160, and outputter 170. Obtainer 110 obtains a collected-sound signal generated through sound collection by microphone 11. Detector 120 detects, based on the collected-sound signal, a noise level in second space 202 where microphone 11 is disposed. First generator 140 generates a first masker sound signal according to the noise level detected by detector 120. Second generator 150 generates, according to the noise level, a second masker sound signal that has a sound pressure higher than a sound pressure of the first masker sound signal in a frequency band higher than a first frequency. Synthesizer 160 synthesizes the first masker sound signal and the second masker sound signal. Outputter 170 outputs, to loudspeaker device 12, the synthesized masker sound signal obtained as a result of the synthesis.

With this, the first masker sound signal and the second masker sound signal are generated to achieve an optimal equivalent noise level corresponding to the noise level. Thus, loudspeaker device 12 emits the synthesized masker sound based on the synthesized masker sound signal into first space 201. As a result, the impact of the noise in second space 202 on a person using first space 201 can be effectively reduced. Hence, the sound signal for providing a comfortable sound environment to the person who is using first space 201 can be provided.

First generator 140 included in masker sound generation device 100 according to the present embodiment generates the first masker sound signal in a way that the highest frequency is lower as the noise level is higher. When the sound pressure of the first masker sound based on the first masker sound signal is adjusted to be at least a predetermined value, sound in the high frequency band is likely to cause discomfort to the person. For this reason, the first masker sound signal is generated in the way that the highest frequency is lower as the noise level is higher. With this, the sound that adversely affects the person can be cut off. Hence, the masker sound for reducing the discomfort caused to the person can be generated.

Second generator 150 included in masker sound generation device 100 according to the present embodiment generates the second masker sound signal in a way that the lowest frequency is higher as the noise level is higher. A second masker sound based on the second masker sound signal has characteristics in the high frequency band. Thus, when the sound pressure of the second masker sound signal is adjusted to increase with the noise level, the low frequency band in which this signal has less characteristics is also accentuated. For this reason, the second masker sound signal is generated in the way that the lowest frequency is higher as the noise level is higher. With this, the high frequency band in which this signal has the characteristics remains. Furthermore, although the high frequency band of the first masker sound signal is cut off, the high frequency band can be compensated for by the second masker sound signal. Hence, the sound signal for providing a more comfortable sound environment to the person who is using first space 201 can be provided.

At the noise level that is at least threshold value Th3 (the first threshold value), first generator 140 of masker sound generation device 100 according to the present embodiment generates the first masker sound signal in a way that allows the full frequency band to be cut off. Furthermore, in this case, second generator 150 of masker sound generation device 100 generates the second masker sound signal to reach the equivalent noise level corresponding to the noise level and to allow a frequency band lower than the first frequency to be cut off.

When the sound pressure of the first masker sound based on the first masker sound signal is adjusted to be at least a predetermined value, sound in the high frequency band is likely to cause discomfort to a person. For this reason, at the noise level that is higher than threshold value Th3 (the first threshold), the first masker sound signal is generated in the way that allows the full frequency band to be cut off (that is, allows the sound pressure to be 0 over the full frequency band). With this, the sound that adversely affects the person can be cut off. The second masker sound based on the second masker sound signal has characteristics in the high frequency band. Thus, when the sound pressure of the second masker sound signal is adjusted to increase with the noise level, the low frequency band in which this signal has less characteristics is also accentuated. For this reason, the second masker sound signal is generated in the way that the lowest frequency is higher as the noise level is higher. With this, the high frequency band in which this signal has the characteristics remains. Hence, the sound signal for providing a comfortable sound environment to the person who is using first space 201 can be provided.

At the noise level that is at least threshold value Th1 (the second threshold value) and less than threshold value Th3 (the first threshold value), first generator 140 generates the first masker sound signal to achieve the equivalent noise level corresponding to the noise level and the second generator generates the second masker sound signal to achieve the equivalent noise level corresponding to the noise level.

With this, the first masker sound signal and the second masker sound signal are generated to achieve an optimal equivalent noise level corresponding to the noise level. As a result, the impact of the noise in second space 202 on the person using second space 202 can be effectively reduced. Hence, the sound signal for providing a comfortable sound environment to the person who is using first space 201 can be provided.

At the noise level that is at least threshold value Th2 (the third threshold value) and less than threshold value Th3 (the first threshold value), first generator 140 generates the first masker sound signal in the way that allows the frequency band higher than frequency f1 (the second frequency) to be cut off and second generator 150 generates the second masker sound signal in the way that allows the frequency band lower than frequency f2 (the first frequency) to be cut off.

When the sound pressure of the first masker sound based on the first masker sound signal is adjusted to be at least a predetermined value, sound in the high frequency band is likely to cause discomfort to a person. For this reason, at the noise level that is higher than threshold value Th1 (the second threshold), the first masker sound signal is generated in the way that allows the frequency band higher than frequency f1 (the second frequency) to be cut off. With this, the sound that adversely affects the person can be cut off. Furthermore, the second masker sound based on the second masker sound signal has characteristics in the high frequency band. Thus, when the sound pressure of the second masker sound signal is adjusted to increase with the noise level, the low frequency band in which this signal has less characteristics is also accentuated. For this reason, the second masker sound signal is generated in the way that allows the frequency band lower than frequency f2 to be cut off. With this, the high frequency band in which this signal has the characteristics remains. Hence, the sound signal for providing a comfortable sound environment to the person who is using first space 201 can be provided.

At the noise level that is less than threshold value Th2 (the second threshold value), first generator 140 generates the first masker sound signal to achieve the equivalent noise level corresponding to threshold value Th1 (the second threshold value) and second generator 150 generates the second masker sound signal to achieve the equivalent noise level corresponding to threshold value Th1 (the second threshold value).

With this, at the noise level that is less than threshold value Th1 (the second threshold value), the first masker sound signal and the second masker sound signal are generated to achieve the equivalent noise level corresponding to threshold value Th1 (the second threshold value). Thus, the first masker sound signal and the second masker sound signal can be generated to achieve an optimal equivalent noise level corresponding to the noise level. Hence, the sound signal for providing a comfortable sound environment to the person who is using first space 201 can be provided.

### Embodiment 2

Masker sound generation system 1A according to Embodiment 2 is different from masker sound generation system 1 according to Embodiment 1 in that masker sound generation device 100A determines, using video of first space 201 captured by camera 14, an activity of a person present in first space 201 and then generating a first masker sound signal and a second masker sound signal also reflecting the determined activity of the person. Although masker sound generation system 1A according to Embodiment 2 is described hereafter, the following mainly describes components of masker sound generation system 1A that are different from the components of masker sound generation system 1 according to Embodiment 1. Note that components identical to those of masker sound generation system 1 according to Embodiment 1 are assigned the same reference numerals as used in Embodiment 1 and thus descriptions of these components are omitted from Embodiment 2.

### 2-1. Configuration

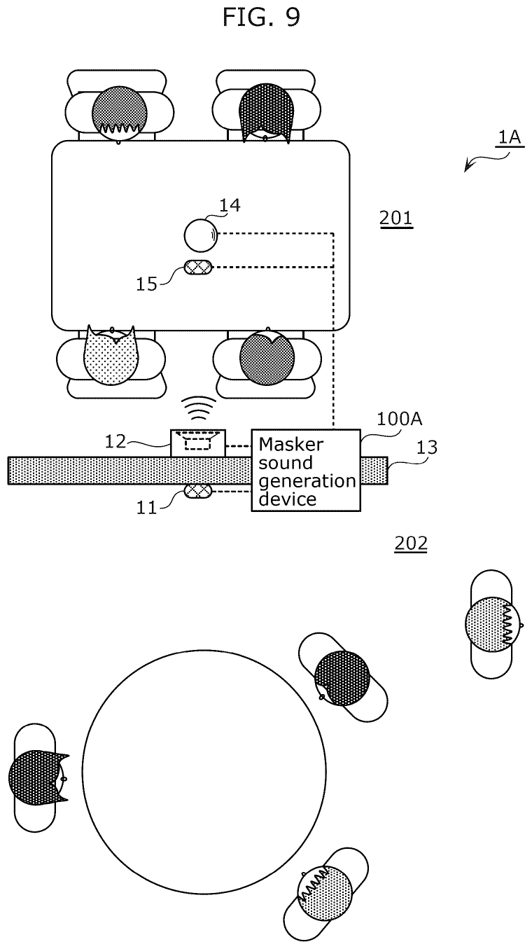

FIG. 9 is a diagram illustrating an example of using the masker sound generation system according to Embodiment 2. Note that FIG. 9 is a top view of masker sound generation system 1A.

Masker sound generation system 1A further includes camera 14 and microphone 15 disposed in first space 201. Camera 14 and microphone 15 are disposed on a desk disposed in first space 201, for example. Note that although camera 14 is disposed on the desk, this is not intended to be limiting. As long as camera 14 is able to image first space 201, camera 14 may be disposed on the ceiling of first space 201 or a wall of first space 201. Alternatively, camera 14 may be disposed in second space 202 as long as camera 14 is able to image first space 201. Similarly, although microphone 15 is disposed on the desk, this is not intended to be limiting. As long as microphone 15 collects sound in first space 201, microphone 15 may be disposed on the ceiling of first space 201 or a wall of first space 201. Alternatively, microphone 15 may be disposed in second space 202 as long as microphone 15 is able to collect sound in first space 201.

Camera 14 is capable of capturing an image covering a full sphere or a hemisphere, for example, and thus capable of imaging at least one person present in the vicinity of the desk. As long as camera 14 is able to image the whole of first space 201, camera 14 need not be capable of capturing an image covering a full sphere or a hemisphere. Camera 14 may be a combination of a plurality of cameras. A video signal obtained by camera 14 is a moving image signal, for example. Camera 14 outputs the video signal obtained by imaging first space 201 in real time to masker sound generation device 100A.

Microphone 15 may be of the same type as microphone 11 or of a different type from microphone 11.

Note that a hardware configuration of masker sound generation device 100A is identical to that of masker sound generation device 100 according to Embodiment 1 and thus description of this hardware configuration is omitted here.

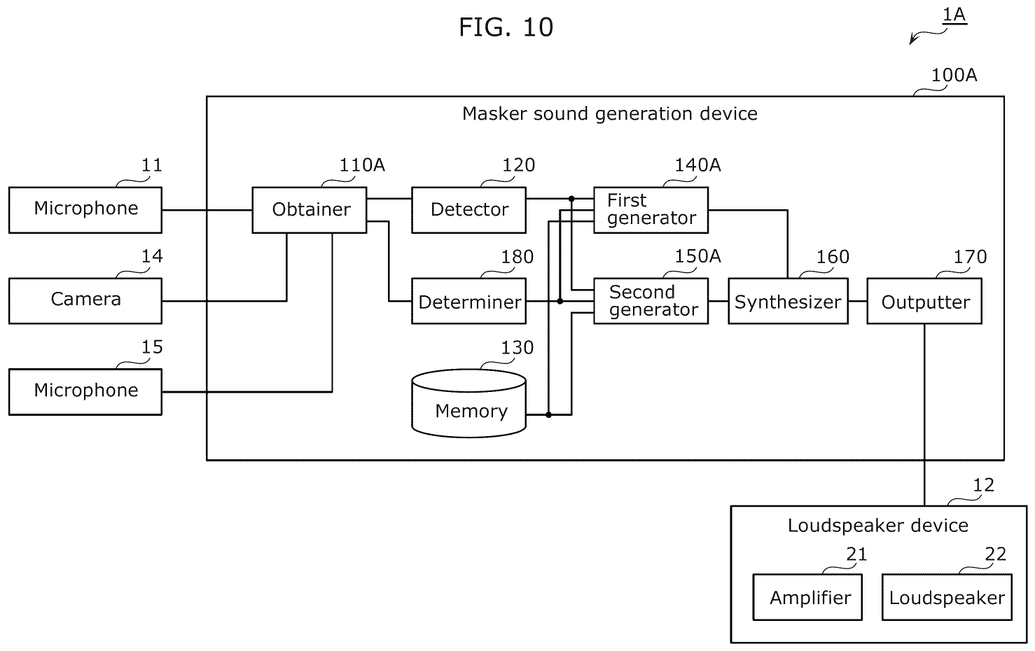

FIG. 10 is a block diagram illustrating an example of a functional configuration of the masker sound generation device according to Embodiment 2.

As illustrated in FIG. 10, masker sound generation device 100A is different from masker sound generation device 100 in further including determiner 180 and in functions of obtainer 110A, first generator 140A, and second generator 150A.

In addition to obtaining a collected-sound signal from microphone 11, obtainer 110A further obtains, from camera 14, a video signal obtained through image capture by camera 14 and also obtains, from microphone 15, a collected-sound signal collected by microphone 15.

Determiner 180 determines an activity of at least one person (hereafter, referred to as the “activity of the person”) present in first space 201. To be more specific, determiner 180 determines whether the activity of the person in first space 201 is a break or an intellectual activity by analyzing the video signal of first space 201 obtained from camera 14 and the collected-sound signal obtained from microphone 15. Note that the intellectual activity is different from a physical activity, such as exercise, and refers to a thinking activity of the person. The intellectual activity includes an activity that does not involve physical movement of the person. Furthermore, when the activity of the person is an intellectual activity, determiner 180 further determines whether this intellectual activity is performed by at least two persons or by one person. The intellectual activity performed by at least two persons is a conference, for example. The intellectual activity performed by one person is solo work, for example. For example, determiner 180 detects the line of sight of the person appearing in the video represented by the video signal and determines, based on the detected line of sight, whether the activity of the person is a break, a conference, or solo work. Determiner 180 determines the activity of the person in real time and then outputs the result of the determination to first generator 140A and second generator 150A. A method executed by determiner 180 for determining the activity of the at least one person is described in detail later. Determiner 180 is implemented by processor 101 executing a program stored in storage 103 using main memory 102, for example.

In addition to the function of first generator 140 according to Embodiment 1, first generator 140A further generates the first masker sound signal to achieve an equivalent noise level corresponding the activity of one person determined by determiner 180. To be more specific, when determiner 180 determines that the activity of the person is a break, first generator 140A generates the first masker sound signal to achieve the equivalent noise level higher than the equivalent noise level achieved when determiner 180 determines that the activity is an intellectual activity. Furthermore, when determiner 180 determines that the activity of the person is an intellectual activity performed by at least two persons (that is, a conference), first generator 140A generates the first masker sound signal to achieve the equivalent noise level higher than the equivalent noise level achieved when determiner 180 determines that the activity is an intellectual activity performed by one person (that is, solo work).

In addition to the function of second generator 150 according to Embodiment 1, second generator 150A further generates the second masker sound signal to achieve the equivalent noise level corresponding the activity of the one person determined by determiner 180. To be more specific, when determiner 180 determines that the activity of the person is the break, second generator 150A generates the second masker sound signal to achieve the equivalent noise level higher than the equivalent noise level achieved when determiner 180 determines that the activity is the intellectual activity. Furthermore, when determiner 180 determines that the activity of the person is the intellectual activity performed by the at least two persons (that is, the conference), second generator 150A generates the second masker sound signal to achieve the equivalent noise level higher than the equivalent noise level achieved when determiner 180 determines that the activity is the intellectual activity performed by the one person (that is, the solo work).

### [First Masker Sound Signal and Second Masker Sound Signal]

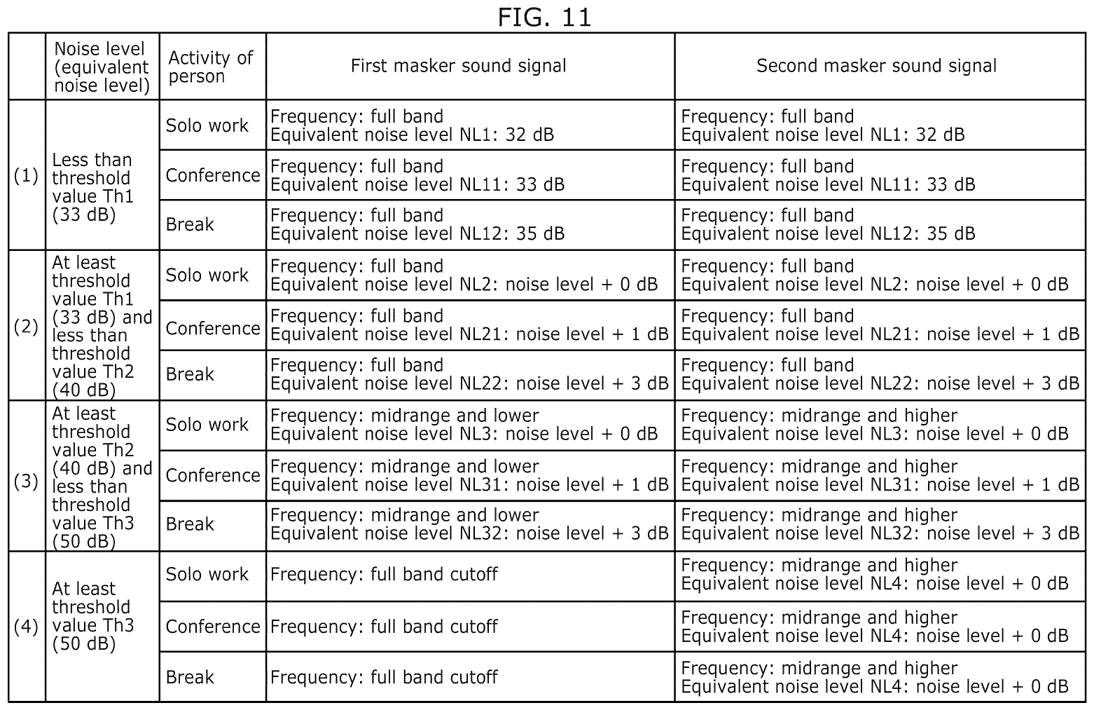

Next, specific examples of the first masker sound signal generated by first generator 140A and the second masker sound signal generated by second generator 150A are described with reference to FIG. 11.

FIG. 11 is a table illustrating an overview of the method of generating the first masker sound signal and the second masker sound signal according to the noise level, according to Embodiment 2.

As illustrated in FIG. 11, in the cases of (1) to (3) where the noise level is less than threshold value Th3, each of the first masker sound signal and the second masker sound signal is generated differently depending on not only the noise level but also the activity of the person. To be more specific, when the activity of the person is solo work, the first masker sound signal and the second masker sound signal are generated in the same way as in Embodiment 1. When the activity of the person is a conference, the first masker sound signal and the second masker sound signal are generated to achieve the equivalent noise level obtained by adding a first sound pressure difference (1 dB, for example) to the first masker sound signal and the second masker sound signal generated when the activity of the person is solo work. When the activity of the person is a break, the first masker sound signal and the second masker sound signal are generated to achieve the equivalent noise level obtained by adding a second sound pressure difference (3 dB, for example) to the first masker sound signal and the second masker sound signal generated when the activity of the person is solo work. Note that the second sound pressure difference is greater than the first sound pressure difference.

More specifically, in the case of (1) where the noise level is less than threshold value Th1, equivalent noise level NL11 that is the target value of the sound pressure of the first masker sound signal and the second masker sound signal generated when the activity of the person is a conference is obtained by adding the first sound pressure difference to equivalent noise level NL1 that is the target value of the sound pressure of the first masker sound signal and the second masker sound signal generated when the activity of the person is solo work. Equivalent noise level NL12 that is the target value of the sound pressure of the first masker sound signal and the second masker sound signal generated when the activity of the person is a break is obtained by adding the second sound pressure difference to equivalent noise level NL1.

Furthermore, in the case of (2) where the noise level is at least threshold value Th1 and less than threshold value Th2, equivalent noise level NL21 that is the target value of the sound pressure of the first masker sound signal and the second masker sound signal generated when the activity of the person is a conference is obtained by adding the first sound pressure difference to equivalent noise level NL2 that is the target value of the sound pressure of the first masker sound signal and the second masker sound signal generated when the activity of the person is solo work. Equivalent noise level NL22 that is the target value of the sound pressure of the first masker sound signal and the second masker sound signal generated when the activity of the person is a break is obtained by adding the second sound pressure difference to equivalent noise level NL2.

Furthermore, in the case of (3) where the noise level is at least threshold value Th2 and less than threshold value Th3, equivalent noise level NL31 that is the target value of the sound pressure of the first masker sound signal and the second masker sound signal generated when the activity of the person is a conference is obtained by adding the first sound pressure difference to equivalent noise level NL3 that is the target value of the sound pressure of the first masker sound signal and the second masker sound signal generated when the activity of the person is solo work. Equivalent noise level NL32 that is the target value of the sound pressure of the first masker sound signal and the second masker sound signal generated when the activity of the person is a break is obtained by adding the second sound pressure difference to equivalent noise level NL3.

Furthermore, in the case of (4) where the noise level is at least threshold value Th3, the noise level is high and thus the sound pressure of the second masker sound signal is sufficiently high. On this account, each of the first masker sound signal and the second masker sound signal is generated in the same way as in Embodiment 1 regardless of the activity of the person. In this case, the target value of the sound pressure of the first masker sound signal and the second masker sound signal is equivalent noise level NL4.

### 2-2. Operation

Next, an operation performed by masker sound generation device 100A according to Embodiment 2 is described.

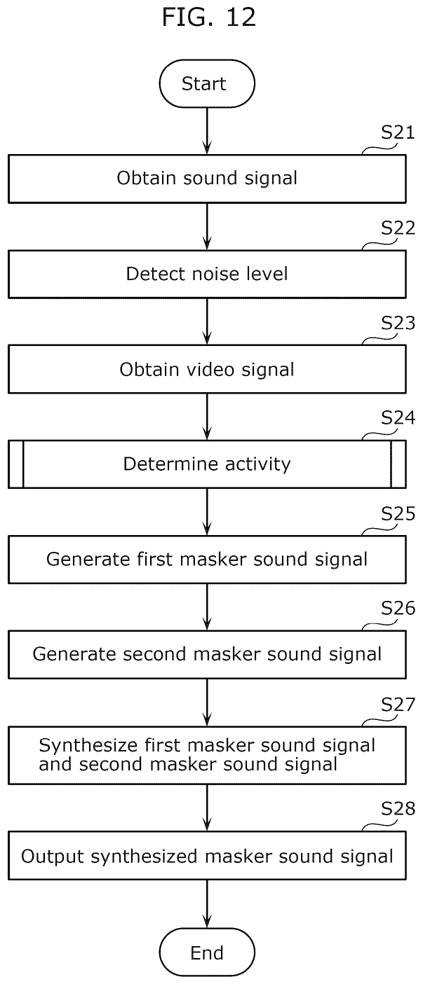

FIG. 12 is a flowchart illustrating a masker sound generation method executed by the masker sound generation device according to Embodiment 2.

Note that Step S21, Step S22, Step S27, and Step S28 are identical respectively to Step S11, Step S12, Step S15, and Step S16 according to Embodiment 1 and thus descriptions of these steps are omitted here.

After Step S22, obtainer 110A obtains the video signal generated through image capture by camera 14 (S23).

Next, determiner 180 determines the activity of the person present in first space 201 (S24).

Next, first generator 140A generates the first masker sound signal by processing, according to the noise level detected by detector 120 and the activity of the person determined by determiner 180, a sound signal representing the first sound source data (S25). To be more specific, first generator 140A generates the first masker sound signal in the way as described with reference to FIG. 11.

Next, second generator 150A generates the second masker sound signal by processing, according to the noise level detected by detector 120 and the activity of the person determined by determiner 180, a sound signal representing the second sound source data (S26). To be more specific, second generator 150A generates the second masker sound signal in the way as described with reference to FIG. 11.

Note that the order in which Steps S21 and S22 and Steps S23 and S24 are performed is not limited to the order described above. Steps S23 and S24 may be performed before Steps S21 and S22. Alternatively, Steps S21 and S22 and Steps S23 and S24 may be performed concurrently.

Note that the order in which Step S25 and Step S26 are performed is not limited to the order described above. Step S25 may be performed before Step S26. Alternatively, Step S25 and Step S26 may be performed concurrently.

The execution of Step S28 enables loudspeaker device 12 to emit the synthesized masker sound based on the synthesized masker sound signal into first space 201.

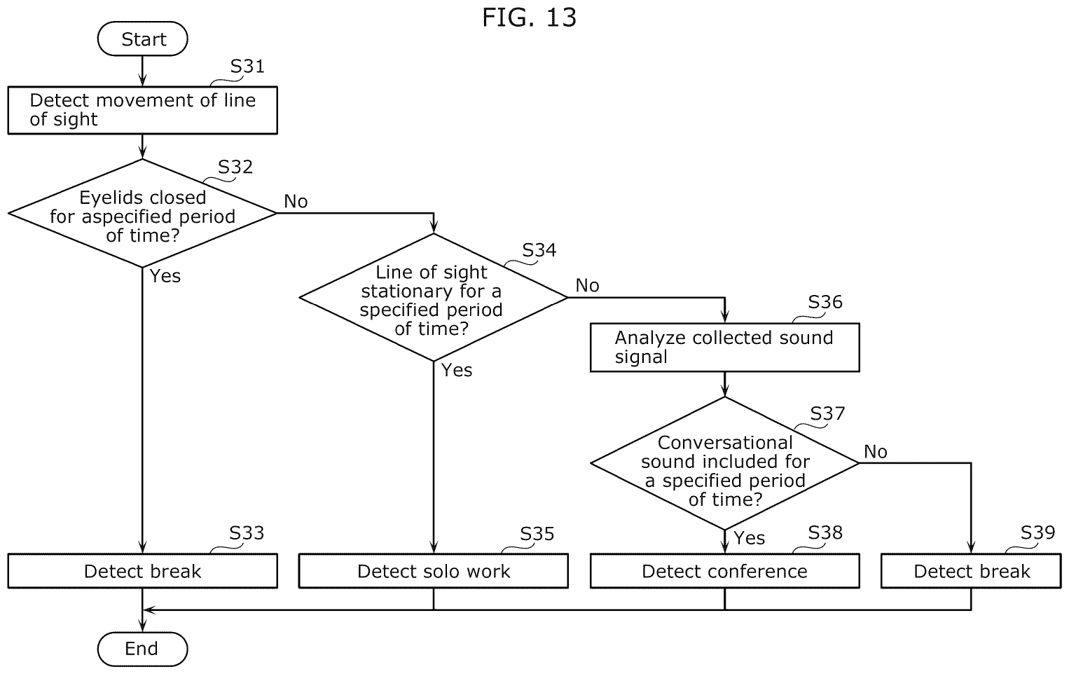

Next, a specific example of the activity determination method executed in Step S24 is described with reference to FIG. 13.

FIG. 13 is a flowchart illustrating an example of the activity determination method executed by the determiner.

Determiner 180 analyzes the video signal generated through image capture by camera 14 and then detects movement of the line of sight (movement of the eyes of the person) included in the video represented by the video signal (S31).

Next, determiner 180 determines whether the person keeps the eyelids closed for a specified period of time (S32).

When determining that the person keeps the eyelids closed for the specified period of time (Yes in S32), determiner 180 determines that the activity of the person is a break (S33).

When determining that the person does not keep the eyelids closed for the specified period of time (No in S32), determiner 180 determines whether the line of sight has been stationary for a specified period of time (S34). When the amount of movement of the line of sight is a predetermined amount or less, determiner 180 determines that the line of sight has been stationary.

When determining that the line of sight has been stationary for the specified period of time (Yes in S34), determiner 180 determines that the activity of the person is solo work (S35).

When determining that the line of sight has not been stationary for the specified period of time (No in S34), determiner 180 analyzes the collected-sound signal obtained from microphone 15 (S36). Then, determiner 180 determines whether the collected-sound signal includes d time period of conversational sound (S37). When the collected-sound signal obtained from microphone 15 includes voices of a plurality of persons, determiner 180 may determine that the conversational sound is included.

When determining that the specified time period of conversational sound is included (Yes in S37), determiner 180 determines that the activity of the person is a conference (S38).

When determining that the specified time period of conversational sound is not included (No in S37), determiner 180 determines that the activity of the person is a break (S39).

### 2-3. Advantageous Effects Etc.

Masker sound generation device 100A according to the present embodiment further includes determiner 180. Determiner 180 determines the activity of the at least one person present in first space 201. When determiner 180 determines that the activity of the person is a break, first generator 140A generates the first masker sound signal to achieve the equivalent noise level higher than the equivalent noise level achieved when determiner 180 determines that the activity of the person is an intellectual activity. When determiner 180 determines that the activity of the person is the break, second generator 150A generates the second masker sound signal to achieve the equivalent noise level higher than the equivalent noise level achieved when determiner 180 determines that the activity of the person is the intellectual activity.

It was found that a person is able to take a break more efficiently when the sound pressure of the masker sound is higher than the sound pressure used during an intellectual activity. On this account, the equivalent noise level of the masker sound signal generated during a break is made higher than the equivalent noise level of the masker sound signal generated during an intellectual activity. This allows the person to take a break more efficiently.

When determiner 180 determines that the activity of the person is an intellectual activity performed by at least two persons, first generator 140A included in masker sound generation device 100A according to the present embodiment generates the first masker sound signal to achieve the equivalent noise level higher than the equivalent noise level achieved when determiner 180 determines that the activity is an intellectual activity performed by one person. When determiner 180 determines that the activity of the person is the intellectual activity performed by the at least two persons, second generator 150A generates the second masker sound signal to achieve the equivalent noise level higher than the equivalent noise level achieved when determiner 180 determines that the activity is the intellectual activity performed by the one person.

It was found that when a person performs an intellectual activity together with at least one person, the person is able to perform the intellectual activity more efficiently when the sound pressure of the masker sound signal is higher than the sound pressure used when the person performs the intellectual activity alone. On this account, the equivalent noise level of the masker sound signal generated during an intellectual activity performed by a plurality of persons is made higher than the equivalent noise level of the masker sound signal generated during an intellectual activity performed by one person. This allows the person to perform the intellectual activity more efficiently.

### OTHER EMBODIMENTS

Masker sound generation device 100 according to Embodiment 1 may be connected to microphone 11 and loudspeaker device 12 through a wired or wireless connection. For the wireless connection, masker sound generation device 100 may be communicatively connected to microphone 11 and loudspeaker device 12 via a network, such as the Internet. In this case, masker sound generation device 100 may be a server.

Similarly, masker sound generation device 100A according to Embodiment 2 may be connected to microphone 11, microphone 15, loudspeaker device 12, and camera 14 through a wired or wireless connection. For the wireless connection, masker sound generation device 100A may be communicatively connected to microphone 11, microphone 15, loudspeaker device 12, and camera 14 via a network, such as the Internet. In this case, masker sound generation device 100A may be a server.

Although memory 130 in each of masker sound generation device 100 according to Embodiment 1 and masker sound generation device 100A according to Embodiment 2 stores the sound source data, this is not intended to be limiting. Each of masker sound generation device 100 and masker sound generation device 100A may download the sound source data from a server.

Each of masker sound generation device 100 according to Embodiment 1 and masker sound generation device 100A according to Embodiment 2 may obtain a digital collected-sound signal or an analogue collected-sound signal from microphone 11. Similarly, masker sound generation device 100A may obtain a digital video signal or an analogue video signal from camera 14.

Although microphone 11 and loudspeaker device 12 are separate from masker sound generation device 100 in Embodiment 1, this is not intended to be limiting. Masker sound generation device 100 may include (incorporate) microphone 11 and loudspeaker device 12. Similarly, although microphone 11, microphone 15, loudspeaker device 12, and camera 14 are separate from masker sound generation device 100A in Embodiment 2, this is not intended to be limiting. Masker sound generation device 100A may include (incorporate) microphone 11, microphone 15, loudspeaker device 12, and camera 14.

Each of the elements in each of the above embodiments may be configured in the form of an exclusive hardware product, or may be realized by executing a software program suitable for the element. Each of the elements may be realized by means of a program executing unit, such as a Central Processing Unit (CPU) or a processor, reading and executing the software program recorded on a recording medium such as a hard disk or semiconductor memory.

The elements may be implemented to circuits (or integrated circuits). These circuits may form a single circuit, or serve as separate circuits. Each circuit may be may be a general-purpose circuit or a dedicated circuit.

General or specific aspects of the present disclosure may be implemented to a system, a device, a method, an integrated circuit, a computer program, a non-transitory computer-readable recording medium such as a Compact Disc-Read Only Memory (CD-ROM), or any given combination thereof.

For example, the present disclosure may be implemented to a masker sound generation method executed by a masker sound generation device (a computer or a digital signal processing (DSP)), or may be implemented to a program for causing a computer or a DSP to execute the masker sound generation method.

For example, it is possible in the above-described embodiments that the process performed by a certain processing unit may be performed by another processing unit, that an order of a plurality of processes performed by the masker sound generation system described in the above embodiments is changed, or that a plurality of processes are performed in parallel.

In addition, the present disclosure may include embodiments obtained by making various modifications on the above embodiments which those skilled in the art will arrive at, or embodiments obtained by selectively combining the elements and functions disclosed in the above embodiments, without materially departing from the scope of the present disclosure.

### INDUSTRIAL APPLICABILITY

The present disclosure is useful to a masker sound generation device that is capable of generating a sound signal to provide a comfortable sound environment to a person who is using a space, for example.

1. A masker sound generation device comprising:
an obtainer that obtains a collected-sound signal generated through sound collection by a microphone;
a detector that detects, based on the collected-sound signal, a noise level in a sound collection space where the microphone is disposed;
a first generator that generates a first masker sound signal according to the noise level;
a second generator that generates, according to the noise level, a second masker sound signal having a sound pressure higher than a sound pressure of the first masker sound signal in a frequency band higher than a first frequency;
a synthesizer that synthesizes the first masker sound signal and the second masker sound signal to generate a synthesized masker sound signal; and
an outputter that outputs the synthesized masker sound signal to a loudspeaker that emits sound into a sound emission space.

2. The masker sound generation device according to claim 1,
wherein the first generator generates the first masker sound signal having a highest frequency that is lower as the noise level is higher.

3. The masker sound generation device according to claim 1,
wherein the second generator generates the second masker sound signal having a lowest frequency that is higher as the noise level is higher.

4. The masker sound generation device according to claim 2,
wherein the second generator generates the second masker sound signal having a lowest frequency that is higher as the noise level is higher.

5. The masker sound generation device according to claim 4,
wherein when the noise level is at least a first threshold value,
the first generator generates the first masker sound signal from which a full frequency band is cut off and
the second generator generates the second masker sound signal which has an equivalent noise level corresponding to the noise level and from which a frequency band lower than the first frequency is cut off.

6. The masker sound generation device according to claim 4,
wherein when the noise level is at least a second threshold value and is less than the first threshold value, the second threshold value being less than the first threshold value,
the first generator generates the first masker sound signal having an equivalent noise level corresponding to the noise level and
the second generator generates the second masker sound signal having the equivalent noise level corresponding to the noise level.

7. The masker sound generation device according to claim 6,
wherein when the noise level is at least a third threshold value and is less than the first threshold value, the third threshold value being greater than the second threshold value and less than the first threshold value,
the first generator generates the first masker sound signal from which a frequency band higher than a second frequency is cut off and
the second generator generates the second masker sound signal from which a frequency band lower than the first frequency is cut off.

8. The masker sound generation device according to claim 6,
wherein when the noise level is less than the second threshold value,
the first generator generates the first masker sound signal having an equivalent noise level corresponding to the second threshold value and
the second generator generates the second masker sound signal having the equivalent noise level corresponding to the second threshold value.

9. The masker sound generation device according to claim 1, further comprising:
a determiner that determines an activity of at least one person present in the sound emission space,
wherein when the determiner determines that the activity is a break, the first generator generates the first masker sound signal having an equivalent noise level higher than an equivalent noise level achieved when the determiner determines that the activity is an intellectual activity, and
when the determiner determines the activity is the break, the second generator generates the second masker sound signal having the equivalent noise level higher than the equivalent noise level achieved when the determiner determines that the activity is the intellectual activity.

10. The masker sound generation device according to claim 9,
wherein when the determiner determines that the activity is an intellectual activity performed by at least two persons, the first generator generates the first masker sound signal having an equivalent noise level higher than an equivalent noise level achieved when the determiner determines that the activity is an intellectual activity performed by one person, and
when the determiner determines that the activity is the intellectual activity performed by the at least two persons, the second generator generates the second masker sound signal having the equivalent noise level higher than the equivalent noise level achieved when the determiner determines that the activity is the intellectual activity performed by the one person.

11. The masker sound generation device according to claim 1, further comprising:
the microphone; and
the loudspeaker,
wherein the microphone is disposed in a direction opposite to a direction in which the loudspeaker emits sound.

12. The masker sound generation device according to claim 1,
wherein the first masker sound signal is a sound signal for masking noise, and
the second masker sound signal is a sound signal for embellishing a first masker sound based on the first masker sound signal.

13. A masker sound generation method executed by a computer, the masker sound generation method comprising:
obtaining a collected-sound signal generated through sound collection by a microphone;
detecting, based on the collected-sound signal, a noise level in a sound collection space where the microphone is disposed;
generating a first masker sound signal according to the noise level;
generating, according to the noise level, a second masker sound signal having a sound pressure higher than a sound pressure of the first masker sound signal in a frequency band higher than a first frequency;
synthesizing the first masker sound signal and the second masker sound signal to generate a synthesized masker sound signal; and
outputting the synthesized masker sound signal to a loudspeaker that emits sound into a sound emission space.

14. A non-transitory computer-readable recording medium for use in a computer, the recording medium having recorded thereon a computer program for causing the computer to execute the masker sound generation method according to claim 13.
